(19) United States
(12) Patent Application Publication
(10) Pub. No.: US 2007/0131792 A1
(43) Pub. Date: Jun. 14, 2007

(54) Spray nozzle shroud

(75) Inventors: Michael Robert Gardner, Anderson, SC (US); Charles Keith Long, Seneca, SC (US)

Correspondence Address: BRINKS HOFER GILSON & LIONE, P.O. BOX 10395, CHICAGO, IL, 60610, US

(73) Assignee: Eastway Fair Company Limited of Trident Chambers

(21) Appl. No.: 11/304,211

(22) Filed: Dec. 14, 2005

(51) Int. Cl. B05B 1/28

(52) U.S. Cl. 239/288; 239/288.3; 239/288.5; 239/600; 239/597; 239/598

(57) ABSTRACT

A nozzle formed by a male insertion member for releasable coupling with a female coupler of a pressure washer. The nozzle may include a tip that is oriented in a direction opposite from the insertion member, and a shroud that at least partially encloses the female coupler when the male insertion member is engaged with the female coupler.

### BACKGROUND

The present invention relates to pressure washers and specifically to nozzles that provide a port for pressurized liquid exiting a wand of a pressure washer. It is often desirable to control the geometry of flow of pressurized liquid that leaves the nozzle of a pressure washer and to quickly and easily switch between multiple nozzles that provide different flow geometries.

Briggs & Stratton manufactures a set of nozzles called the ProjectPro™ system that include male members that are compatible with female quick connect couplers and are sold with varying nozzle aperture geometries. The male end of the nozzle projects from the coupler and thus does not have any protection against damage if dropped or similarly mishandled. Damage to the surface of the male end can cause the nozzle to not properly engage the female coupler or to be expelled from the wand at a high velocity when pressurized fluid flows through the nozzle without proper engagement between the components. This could lead to injury or damage to either the nozzle or surrounding property. The female quick coupler remains exposed when the ProjectPro™ nozzle is inserted into it for operation, which may lead to inadvertent release of nozzle if the movable sleeve of the female quick coupler is mistakenly or accidentally moved with respect to the quick coupler body during use.

### BRIEF SUMMARY

The present invention provides a nozzle for a pressure washer that includes a male insertion member for releasable coupling with a female coupler of a pressure washer. The nozzle includes an insertion member at one end and a tip at the other opposite end. A shroud partially encloses the coupler when the male insertion member is engaged with the female coupler.

Advantages of the present invention will become more apparent to those skilled in the art from the following description of the preferred embodiments of the invention that have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of a nozzle of the present invention.

FIG. 2 is a perspective view of the nozzle of FIG. 1 showing the nozzle separated from a female coupler.

FIG. 3 is a side view of the nozzle of FIG. 1.

FIG. 4 is another side view of the nozzle of FIG. 1.

FIG. 5 is a top view of the nozzle of FIG. 1.

FIG. 6 is a bottom view of the nozzle of FIG. 1.

### DETAILED DESCRIPTION

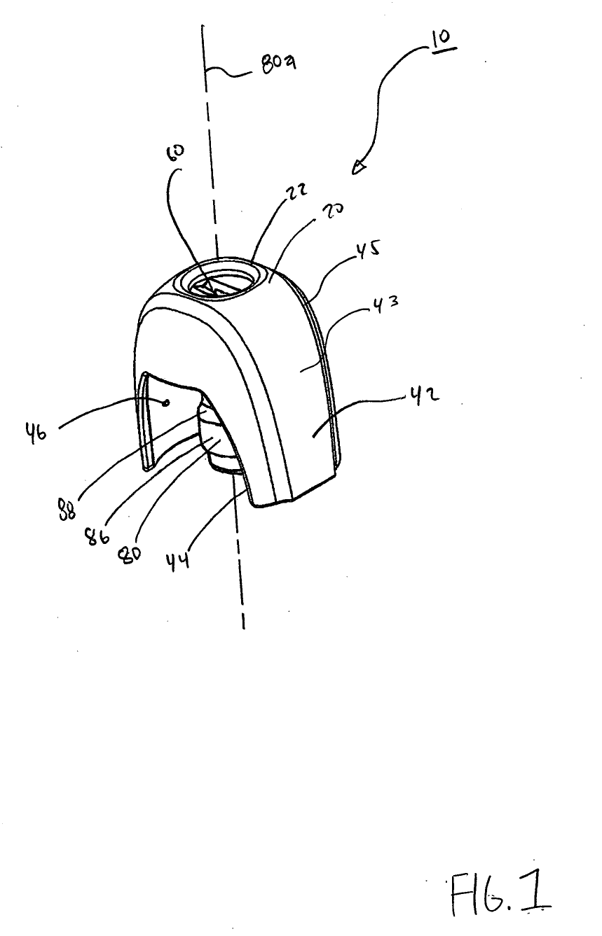

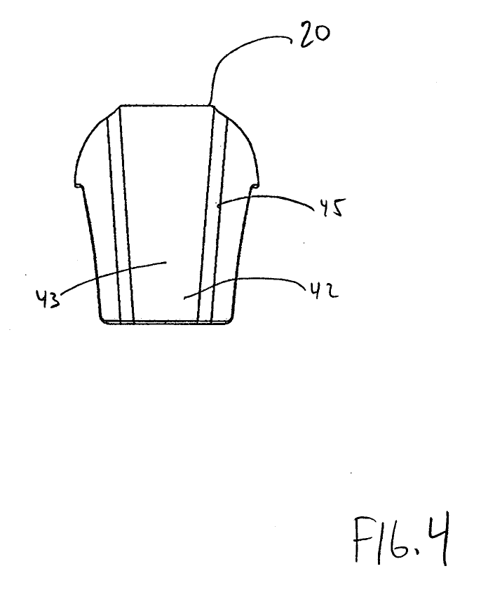

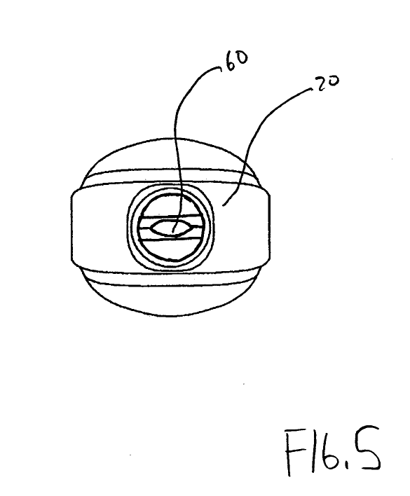

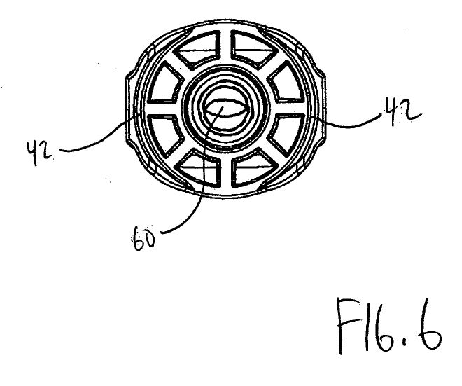

Referring now to FIGS. 1-6, a nozzle 10 for use with a washer is provided. Generally, the nozzle 10 includes a male insertion member 80 that is oriented along a longitudinal axis 80a of the nozzle. A tip 20 is provided at the front, or output, end of the nozzle 10. A shroud 40 that projects rearwardly from the tip 20 is directed substantially in parallel with the longitudinal axis 80a of the nozzle 10. The shroud 40 includes at least one fin and may include a plurality of fins 42 that surround a portion of a female coupler 100 when the nozzle 10 is connected with the female coupler 100 (discussed below).

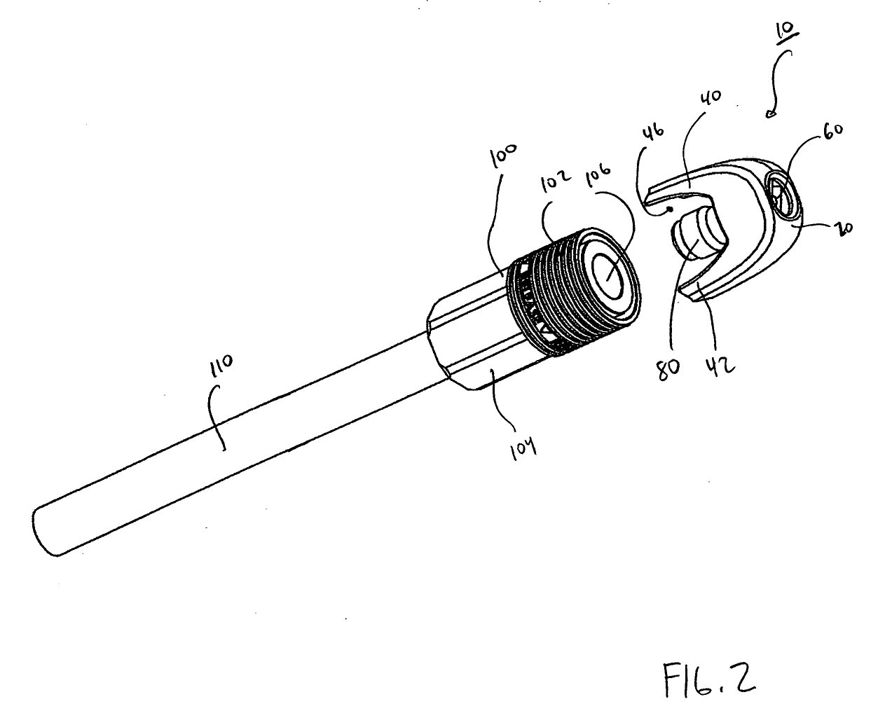

The washer (not shown) can be constructed similarly to conventional pressure washers and provides a quantity of liquid at an increased pressure that flows from the pressure washer to a wand 110. As shown in FIG. 2, the wand 110 normally includes a coupler, specifically, a female quick connect coupler 100. The coupler 100 includes a body 104 and a sleeve 102 that is movable with respect to the body 104 along the longitudinal axis of the body 104 to allow for the retention and the release of a male insertion member 80. The movement of the sleeve 102 causes movement of a plurality of detent balls (not shown) within the coupler 100 to allow releasable engagement with the male insertion member 80. The female coupler 100 includes an exit port 106 that receives the male insertion member 80 where the pressurized fluid exits the female coupler 100.

The nozzle 10 is removably engageable with the female quick connect coupler 100, or other similar type of female couplers, and is provided with a male insertion member 80 that can be inserted into the exit port 106 of the female coupler 100. The male insertion member 80 is formed with a longitudinal axis that is collinear with the longitudinal axis 80a of the nozzle 10 and extends rearward from the nozzle tip 20 (discussed below) in the direction away from pressurized liquid spray exiting the nozzle tip 20.

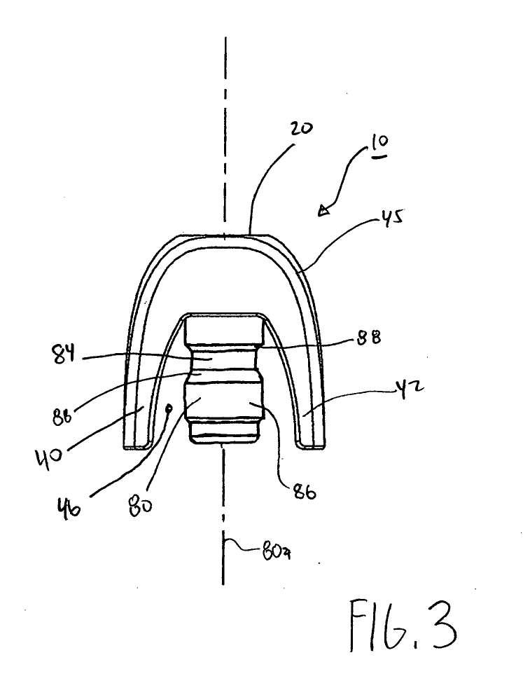

As best shown in FIG. 3, the male insertion member 80 includes a recessed section 84, two wide sections 86 that surround the recessed section 84, and a conical face 88 on each end of the recessed section 84 that forms a transitional surface between the recessed section 84 and each of the wide sections 86. When the male insertion member 80 is fully inserted into the exit port 106 of the female coupler 100, the plurality of detent balls are held in engagement with the recessed section 84 of the member 80. The male insertion member 80 is prevented from movement with respect to the female coupler 100 because the detent balls are prevented from movement radially outward by the sleeve 102 and therefore, the nozzle 10 is prevented from release from the female coupler 100.

The male insertion member 80 can be released from the female coupler 100 by translating the sleeve 102 along a longitudinal axis of the female coupler 100, which removes the biasing force on the detent balls to allow them to move radially outward and engage the conical faces 88 and the wide section 86 of the male insertion member 80.

The nozzle tip 20 is formed at the forward end of the nozzle 10 and is substantially perpendicular to the rearwardly projecting male insertion member 80. The nozzle tip 20 includes an aperture 60 that provides an exit port for pressurized liquid to exit the nozzle 10. The aperture 60 may be formed with a plurality of different geometries that allow for different spray patterns of pressurized fluid exiting the nozzle 10. In some embodiments, the aperture 60 may be formed with a circular cross-section for a linear spray and in other embodiments the aperture 60 may be formed with a straight cross-section to allow for a planar spray. As understood by those of ordinary skill in the art, the geometry of the aperture 60 may be varied in numerous different orientations to provide numerous different spray patterns. Additionally, the aperture 60 may be recessed inwardly from the outer surface of the nozzle tip 20, as shown in FIG. 1. The recessed aperture 60 reduces the likelihood of mechanically fouling the aperture 60 because the aperture 60 is partially protected by the inner edge 22 of the nozzle tip 20. In other embodiments, the aperture 60 may be formed at the outer surface of the nozzle tip 20.

The shroud 40 is provided on the nozzle 10 and extends rearward from the tip 20 and substantially parallel to the longitudinal axis 80a of the male insertion member 80. The shroud 40 is formed with at least one fin 42 and may include a plurality of fins 42. The fin 42 is sized such that the male insertion member 80 cannot contact a flat surface that the nozzle 10 contacts when any portion of nozzle 10 contacts the flat surface. Forming the fin 42 in this manner prevents damage to the male insertion member 80, if the nozzle 10 is inadvertently dropped onto a flat surface, because the fin 42 or the front tip 20 of the nozzle 10 will contact the flat surface, and not the male insertion member 80. The fin 42 surrounds and contacts a portion of the female coupler 100 when the male insertion member 80 is inserted into the exit port 106 of the female coupler 100. Specifically, the fin 42 surrounds and contacts a portion of the sleeve 102. The engagement between the fin 42 and the sleeve 102 aids in securing the nozzle 10 to the female coupler 100 because a significant portion of the sleeve 102 is covered by the fin 42, which prevents the enclosed portion of the sleeve 102 from being manipulated inadvertently.

The nozzle 10 can be manufactured such that the inner diameter of the fin 42 is substantially the same as the outer diameter of the sleeve 102. The nozzle 10 is made from a material, such as plastic, that is sufficiently elastic to allow for sufficient deflection of the fin 42 in the radially outward direction to allow the nozzle shroud 40 to be positioned around the sleeve 102 when the male insertion member 80 is inserted into the exit port 106 of the female member 100. Once the male insertion member 80 is fully inserted and the detent balls engage the recessed section 84, the fin 42 is released and the fin 42 attempts to return to its original inner diameter. The fin 42 provides a biasing force normal to the surface of the sleeve 102, which generates a frictional force that opposes the motion of the sleeve 102 that is required to release the nozzle 10. The combination of surrounding a significant portion of the sleeve 102 and the frictional force generated on the sleeve 102 provides additional protection against inadvertent movement of the sleeve 102 during operation, which could be hazardous because the nozzle 10 would likely become a projectile.

The engagement between the fin 42 and the female coupler 100 also aid in retaining the nozzle to the coupler if the detent balls do not properly engage the recessed portion 84 to retain the nozzle 10 on the coupler 100 when the system is pressurized. In this situation, the engagement between these two components may prevent the nozzle 10 from being expelled from the coupler 100 or reduce the velocity that the nozzle 10 projects from the coupler 100 if pressurized liquid is applied to the nozzle 10 without a proper connection between the two components.

As can be understood with reference to FIG. 2, the geometry of the fin 42 provides windows 46 that expose portions of the sleeve 102 (shown as being opposite) to allow for manipulation of the sleeve 102 when the nozzle 10 is connected with the female coupler 100. The windows 46 are formed to provide sufficient room for a thumb and a finger to contact the sleeve 102 and translate the sleeve 102 with respect to the coupler body 104 to allow for controlled release of the nozzle 10. The fin 42 is formed with a plurality of ridges 45 between a center section 43 of each fin 42 and an inner edge 44 of each fin 42. The ridges 45 provide a surface that can be gripped by the user with enough force to allow for the nozzle 10 to be moved away from the female coupler 100 after the sleeve 102 has been moved to release the detent balls from the recessed section 84 of the male insertion member 80. The ridges are provided because, as discussed above, the inner surface of the fin 42 forms a tight fit with the sleeve 102, and a significant amount of force needs to be applied to the fin 42 to remove the nozzle 10 from the female coupler 100.

It is therefore intended that the foregoing detailed description be regarded as illustrative rather than limiting, and that it be understood that it is the following claims, including all equivalents, that are intended to define the spirit and scope of this invention.

What is claimed:

1. A nozzle for a pressure washer comprising:
a male insertion member having a first end and a second end for releasably coupling with a female coupler; and
a shroud that at least partially encloses the coupler when the male insertion member is engaged with the female coupler.

2. The nozzle of claim 1 wherein the shroud has at least one fin that extends from the first end.

3. The nozzle of claim 2 wherein the at least one fin contacts an outer surface of the coupler when the insertion member is engaged with the coupler.

4. The nozzle of claim 3 wherein the at least one fin provides a connection with the coupler to retain the nozzle engaged with the coupler.

5. The nozzle of claim 1 wherein the female coupler is a female quick connect coupler.

6. The nozzle of claim 1 further comprising an aperture for fluid to exit the nozzle.

7. The nozzle of claim 6 wherein the aperture is provided at the first end.

8. The nozzle of claim 6 wherein the aperture is recessed rearwardly from an outer surface of the first end.

9. The nozzle of claim 2 wherein the at least one fin extends substantially parallel to a longitudinal axis of the male insertion member.

10. The nozzle of claim 1 wherein the shroud provides access to a sleeve on the female coupler.

11. The nozzle of claim 10 wherein the shroud provides an inward biasing force on the movable sleeve to substantially prevent inadvertent movement of the movable sleeve with respect to the remainder of the female coupler.

12. The nozzle of claim 2 wherein the at least one fin includes a plurality of ridges.

13. A nozzle for a pressure washer comprising:
(a) a male insertion member with a longitudinal axis for releasable coupling with a female coupler fluidly connected to a fluid source;
(b) a front face positioned perpendicular to the longitudinal axis of the male insertion member, including a spray aperture; and
(c) at least one fin that extends from the front face of the nozzle.

14. The nozzle of claim 13 wherein the at least one fin contacts the female coupler when the male insertion member is coupled to the female coupler.

15. The nozzle of claim 13 wherein the at least one fin at least partially encloses an outer surface of the female coupler.

16. The nozzle of claim 13 wherein the spray aperture includes a slot to emit a substantially planar spray of fluid.

17. The nozzle of claim 13 wherein the spray aperture is recessed rearwardly from the front face of the nozzle.

18. The nozzle of claim 13 wherein the at least one fin extends substantially parallel to the longitudinal axis of the male insertion member.

19. The nozzle of claim 13 wherein the male insertion member is capable of insertion into a female quick connect coupler.
